(19) United States
(12) Patent Application Publication
(10) Pub. No.: US 2018/0212488 A1
(43) Pub. Date: Jul. 26, 2018

(54) COIL WINDING COMPRISING HF LITZ WIRE, ELECTRICAL MACHINE COMPRISING A COIL WINDING OF THIS KIND, AND METHOD FOR PRODUCING SAID COIL WINDING

(71) Applicant: SCHAEFFLER TECHNOLOGIES AG & CO. KG, Herzogenaurach (DE)

(72) Inventors: Christian KUEHHIRT, Steinbach-Hallenberg (DE); Tristan STEIBERT, Bruenn (DE)

(73) Assignee: SCHAEFFLER TECHNOLOGIES AG & CO. KG, Herzogenaurach (DE)

(21) Appl. No.: 15/745,033

(22) PCT Filed: Jun. 20, 2016
(86) PCT No.: PCT/DE2016/200283

§ 371 Date: Jan. 15, 2018

(30) Foreign Application Priority Data
Jul. 20, 2015 (DE) 10 2015 213 616.7

(51) Int. Cl. H02K 3/12; H02K 3/04; H02K 3/32; H02K 3/30; H02K 15/06; H02K 15/04; H02K 15/10; H02K 15/12

(52) U.S. Cl. CPC H02K 3/12; H02K 3/04; H02K 3/32; H02K 15/12; H02K 15/065; H02K 15/0435; H02K 15/105; H02K 3/30

(57) ABSTRACT

A coil winding for an electrical machine comprising litz wire that includes winding head sections and winding body sections, wherein the litz wire includes one or more baked-enamel wires having an outer layer composed of baked enamel, wherein the winding body sections are baked to one another by baking a baking material of the baked-enamel wires.

### CROSS-REFERENCE TO RELATED APPLICATIONS

This application is the U.S. National Phase of PCT/DE2016/200283 filed Jun. 20, 2016, which claims priority to DE 102015213616.7 filed Jul. 20, 2015, the entire disclosures of which are incorporated by reference herein.

### TECHNICAL FIELD

The disclosure relates to a coil winding for an electrical machine, comprising high-frequency (HF) litz wire. The disclosure also relates to an electrical machine comprising a coil winding of this kind, and a method for producing an electrical machine.

### BACKGROUND

HF litz wire has been used for coil windings for a long time. DE 21 48 057 B2 describes a litz wire for coils consisting of a large number of wires, which are insulated individually and wound together in helical form with at least one thread of textile fibers in such a way that the litz wires are only partially covered.

DE 10 2011 086 280 A1 shows a permanently excited 3-phase synchronous machine having a stator with toothed coil winding, which is configured as fractional slot winding and with rectangular profiled HF litz wire. The HF litz wire comprises a large number of electrically insulated enameled copper wires, which are twisted and subsequently compressed into a rectangular profile. In comparison with uncompressed single wires, the compression results in a significantly higher copper filling factor in the strand cross section.

Furthermore, the use of baked-enamel wires for producing coil windings is well-known. Baked-enamel wire involves a wire, in which the electrically conductive wire also comprises an additional outer layer (composed of baked enamel), in addition to an insulating layer, for example, a coating layer. For example, the baked-enamel layer is a thermoplastic layer. When heated, the baked-enamel layer is softened and can be bonded with a baked-enamel layer of an adjacent wire. This process is also called baking. This process of baking ensures that the geometric shape of the coil is maintained permanently.

DE 103 38452 A1 describes a method for producing a component, which has a coil winding for an electrical machine, as well as an electrical machine, which comprises a component of this kind. The method comprises the following steps: winding one or several wires to a coil. The wire is a baked-enamel wire having an electrically conductive core, an insulating layer and a baked outer layer. Subsequently, the would coil is compressed by means of a pressing tool. Afterwards, the compressed coil is baked to maintain the geometric shape of the coil.

### SUMMARY

It is one objective of this disclosure to provide a coil winding for an electrical machine consisting of HF litz wire, which optimally utilizes a winding space used for receiving the coil winding to achieve a high filling factor and at the same time achieve a low height of the winding head. Furthermore, the disclosure intends to provide an electrical machine having a coil winding of this kind, as well as a method for producing said coil winding.

The task can be achieved by using a coil winding, an electrical machine, as well as a method described below.

The coil winding comprises HF litz wire and extends in winding head sections and winding body sections. The HF litz wire comprises a large number of baked-enamel wires, each having an outer layer which is composed of baked enamel. At least the winding body sections are baked to one another by baking the baking material of the baked-enamel wires. The winding head sections are not baked.

A significant advantage of the described coil winding involves the fact that by using an HF litz wire comprising baked-enamel wires, a groove in which the coil winding in the electrical machine is inserted can be optimally utilized. This is achieved by compressing the HF litz wire, which takes place in the baking process. When compacted the free intermediate spaces between the individual baked-enamel wires are minimized, which results in a maximum filling factor. Because of the fact that the winding head sections of the coil winding are not baked, this region remains flexible. The winding head sections may be compressed in the groove after inserting the coil winding. In this way, it is possible to minimize the height of the winding head, thus minimizing the required installation space. As a result, a relatively high power-output can be produced in a small installation space. By using HF litz wire, skin effects are minimized.

The baked-enamel wire used for producing HF litz wire involves customary baked-enamel wire. For example, it is possible to use a baked-enamel wire having thermoplastic baking material.

The electrical machine comprises the coil winding described above, which is inserted in a groove of the electrical machine.

According to an advantageous embodiment, the winding body sections have an outer insulating layer to ensure a required insulation of the coil winding, depending on the respective application. The insulating layer may be produced by wrapping the baked winding body sections with an appropriate insulating material.

The method for producing an electrical machine comprises the following steps: first, an HF litz wire is wound to a coil winding. The HF litz wire used comprises a large number of baked-enamel wires, each having an outer layer which is composed of baked enamel. Then the coil winding is baked in winding body sections. The baking process may take place in a baking tool, in which the coil winding is inserted. Before or during the baking process, compacting can take place in the region of the winding body sections. At the same time, winding head sections are not baked. Subsequently, the coil winding is inserted in a groove of the electrical machine.

According to another embodiment, the winding head sections are compressed after the coil winding has been inserted in the groove. The compression of the winding head sections results in minimizing the height of the winding head, thus requiring less installation space. The baked winding body sections may depend on the active length of the electrical machine.

It may be advantageous to provide the winding body sections after baking with an insulating layer to ensure the required insulation to the iron packet of the electrical machine.

### BRIEF DESCRIPTION OF DRAWINGS

Preferred embodiments of the disclosure and its advantages and details are subsequently described in more detail by means of the enclosed FIGURE.

FIG. 1 discloses a side view of a coil winding arranged in a baking tool.

### DETAILED DESCRIPTION

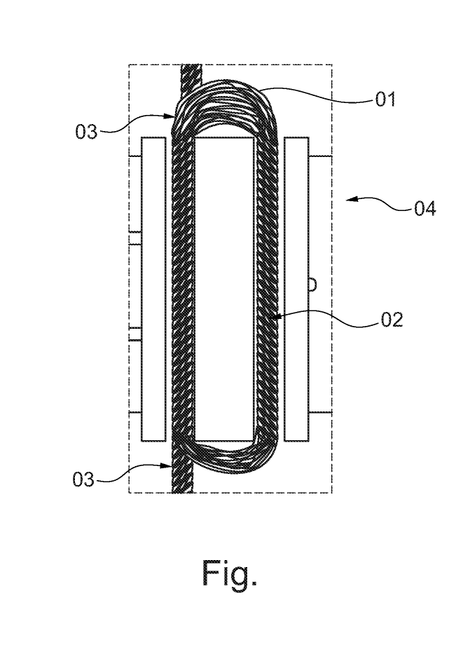

FIG. 1 shows an inventive coil winding 01, which is arranged in a baking tool 04. The coil winding 01 may later become part of an electrical machine (not shown) and can there be inserted in a groove of the electrical machine. The baking tool 04 also comprises a groove, which corresponds to the dimensions of the groove of the electrical machine and in which the actual baking process takes place.

The coil winding 01 consists of an HF litz wire, which comprises a large number of baked-enamel wires. The baked-enamel wires each have an outer layer composed of baked enamel. The coil winding 01 has winding body sections 02 and winding head sections 03. After baking, the winding body sections 02 form a solidified region. This solidified region is produced by baking the baking material of the baked-enamel wires. For this purpose, the winding body sections 02 are inserted in the groove of the baking tool 04.

In the region of the winding head sections 03, the coil winding 01 is not baked and thus remains flexible. After inserting the coil winding 01 in the groove of the electrical machine, the flexible winding head sections 03 can be compressed, which minimizes the height of the winding head. After the baking process, the winding body sections 02 of the coil winding 01 can be provided with an outer insulating layer.

### LIST OF REFERENCE NUMERALS

01 coil winding
02 winding body sections
03 winding head sections
04 baking tool

1. A coil winding for an electrical machine comprising:
litz wire, which extends in winding head sections and winding body sections, wherein the litz wire includes baked-enamel wires having an outer layer which is composed of baked enamel, wherein the winding body sections are baked to one another by baking a baking material of the baked-enamel wires, but not baking the winding head sections.

2. The coil winding of claim 1, wherein the baked-enamel wire includes a thermoplastic baking material.

3. The coil winding of claim 1, wherein two winding body sections extend parallel to one another and run between two winding head sections.

4. (canceled)

5. (canceled)

6. (canceled)

7. A method for producing an electrical machine, comprising:
winding a litz wire to a coil winding, wherein the litz wire comprises of baked-enamel wires having each an outer layer composed of baked enamel;
baking the coil winding in winding body sections, but not baking winding head sections of the coil winding;
inserting the coil winding in a groove of the electrical machine.

8. The method of claim 7, wherein the winding head sections are compressed after inserting the coil winding in the groove.

9. The method of claim 7, wherein the baked winding body sections correspond to an active length of the electrical machine.

10. The method of claim 7, wherein the winding body sections are provided after baking with an insulating layer.

11. A coil winding for an electrical machine, comprising: litz wire that includes winding head sections and winding body sections, wherein the litz wire includes one or more baked-enamel wires having an outer layer composed of baked enamel, wherein the winding body sections are baked to one another by baking a baking material of the baked-enamel wires.

12. The coil winding for an electrical machine of claim 11, wherein the baked-enamel wire includes a thermoplastic baking material.

13. The coil winding for an electrical machine of claim 11, wherein two winding body sections extend parallel to one another and run between two winding head sections.

14. The coil winding for an electrical machine of claim 11, wherein the winding head sections are capable of being compressed.

15. The coil winding for an electrical machine of claim 11, wherein the winding head sections are not baked.

16. The coil winding for an electrical machine of claim 15, wherein the winding head sections are capable of being compressed.

17. The coil winding for an electrical machine of claim 11, wherein the litz wire is a high-frequency (HF) litz wire.

18. The coil winding for an electrical machine of claim 11, wherein the winding body sections include a solidified region.

19. The coil winding for an electrical machine of claim 11, wherein the winding body sections include an outer insulating layer.
